(19) United States
(12) Patent Application Publication
(10) Pub. No.: US 2017/0284567 A1
(43) Pub. Date: Oct. 5, 2017

(54) GROMMET, CONDUIT SUPPORT ASSEMBLY, AND METHOD OF SUPPORTING A CONDUIT

(71) Applicant: The Boeing Company, Chicago, IL (US)

(72) Inventors: Kevin Gaw, Seattle, WA (US); Kevin E. Clark, Kirkland, WA (US); David E. Sterling, Seattle, WA (US); Michelle R. Tuttle, Bellevue, WA (US)

(21) Appl. No.: 15/084,733

(22) Filed: Mar. 30, 2016

(51) Int. Cl. F16L 3/10; F16L 3/12

(52) U.S. Cl. CPC F16L 3/1058; F16L 3/1066; F16L 3/1091; F16L 3/1222

(57) ABSTRACT

A grommet is provided. The grommet includes a radially inner side wall, a radially outer side wall, and a support structure extending between the radially inner side wall and the radially outer side wall. The support structure includes a plurality of channel walls arranged in a grid-like pattern such that a plurality of hollow passages are defined by the plurality of channel walls.

### BACKGROUND

The field of the present disclosure relates generally to mechanical fittings for conduits and, more specifically, to a grommet having an at least partially hollow internal support structure that enables the grommet to have adjustable compliance based on desired installation parameters.

Typically, fluid transport elements, such as conduits, are installed and intermittently supported within structures with a bracket assembly. The conduits extend through the bracket assembly having a defined conduit opening, and the conduits are sometimes supported within the bracket assembly with a grommet. Grommets are typically fabricated in solid form from a polymeric material having a predetermined durometer value (i.e., hardness) to permit radial and lateral movement of the conduit within the bracket assembly. As such, the hardness of the grommet, and thus the amount of radial and lateral movement permitted by the grommet, can only be adjusted by substituting or reformulating the polymeric material used to fabricate the grommet such that the compressibility or hardness of the grommet is modified.

### BRIEF DESCRIPTION

In one aspect, a grommet is provided. The grommet includes a radially inner side wall, a radially outer side wall, and a support structure extending between the radially inner side wall and the radially outer side wall. The support structure includes a plurality of channel walls arranged in a grid-like pattern such that a plurality of hollow passages are defined by the plurality of channel walls.

In another aspect, a conduit support assembly is provided. The conduit support assembly includes a bracket having a conduit opening defined therein, a conduit extending through the conduit opening, and a grommet positioned between the bracket and the conduit within the conduit opening. The grommet includes a radially inner side wall, a radially outer side wall, and a support structure extending between the radially inner side wall and the radially outer side wall. The support structure includes a plurality of channel walls arranged in a grid-like pattern such that a plurality of hollow passages are defined by the plurality of channel walls.

In yet another aspect, a method supporting a conduit within a structure is provided. The method includes mounting a first bracket within the structure, and positioning a first grommet within a conduit opening defined in the first bracket. The first grommet includes a radially inner side wall, a radially outer side wall, and a support structure extending between the radially inner side wall and the radially outer side wall, wherein the support structure includes a plurality of channel walls arranged in a grid-like pattern such that a plurality of hollow passages are defined by the plurality of channel walls. The method further includes extending the conduit through a through-hole defined in the first grommet.

### BRIEF DESCRIPTION OF THE DRAWINGS

FIG. 1 is a perspective view of an exemplary conduit support assembly;

FIG. 2 is a perspective view illustration of an exemplary grommet that may be used in the conduit support assembly shown in FIG. 1;

FIG. 3 is a front view illustration of the grommet shown in FIG. 2;

FIG. 4 is a perspective cross-sectional view of the grommet shown in FIG. 2; and

FIG. 5 is a perspective cross-sectional view of a grommet in accordance with a second implementation of the disclosure.

### DETAILED DESCRIPTION

The implementations described herein relate to mechanical fittings for conduits such as a grommet. More specifically, the grommet described herein includes a radially inner side wall, a radially outer side wall, and a support structure extending between the radially inner side wall and the radially outer side wall. The support structure is at least partially hollow and includes a plurality of channel walls arranged in a grid-like pattern to increase the rigidity of the grommet. Moreover, one or more parameters of the grommet may be modified to adjust the hardness and compressibility of the grommet. For example, the thicknesses of the radially inner side wall, the radially outer side wall, and the plurality of channel walls, and an arrangement of the plurality of channel walls can be modified to tailor the grommet based on a desired holding force of the grommet in a particular assembly. As such, the grommet described herein has reduced weight and is formed from less material than grommets that do not have through-channels, which enables a grommet to be fabricated from higher performing and more costly materials at an equivalent total material cost.

As used herein, an element or step recited in the singular and proceeded with the word “a” or “an” should be understood as not excluding plural elements or steps, unless such exclusion is explicitly recited. Furthermore, references to “exemplary implementation” or “one implementation” of the present disclosure are not intended to be interpreted as excluding the existence of additional implementations that also incorporate the recited features.

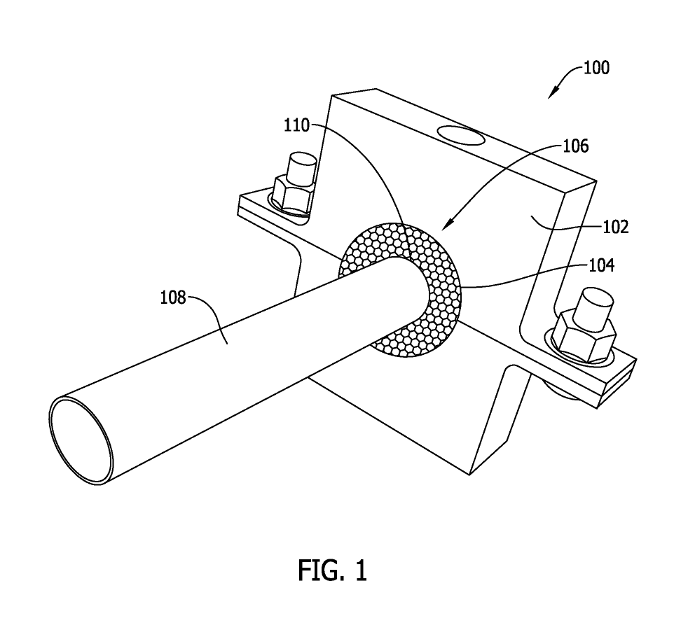

FIG. 1 is a perspective view of an exemplary conduit support assembly 100. In the exemplary implementation, conduit support assembly 100 includes a two-piece bracket 102 having a conduit opening 104 defined therein, and a grommet 106 coupled within bracket 102. A conduit 108 extends through conduit opening 104 and grommet 106 is positioned between bracket 102 and conduit 108 within conduit opening 104. More specifically, conduit 108 extends through a through-hole 110 defined within grommet 106. Conduit 108 is sized to channel fluid such as fuel or hydraulic fluid therethrough, or is capable of housing electrical wiring, for example. Moreover, conduit support assembly 100 may be installed within any suitable structure, such as a building or a vehicle.

In some implementations, a vibrational response is induced to conduit 108 from either the fluid being channeled therethrough, or from one or more forces induced on the structure. For example, in the case of an airframe, conduit 108 may extend within a wing and towards a fuselage (each not shown) of the airframe, and the vibrational response is induced by either turbulence or natural bending of the wing relative to the fuselage. As such, as will be described in more detail below, grommet 106 is fabricated from a flexible material selected to provide vibrational damping and a holding force to conduit 108.

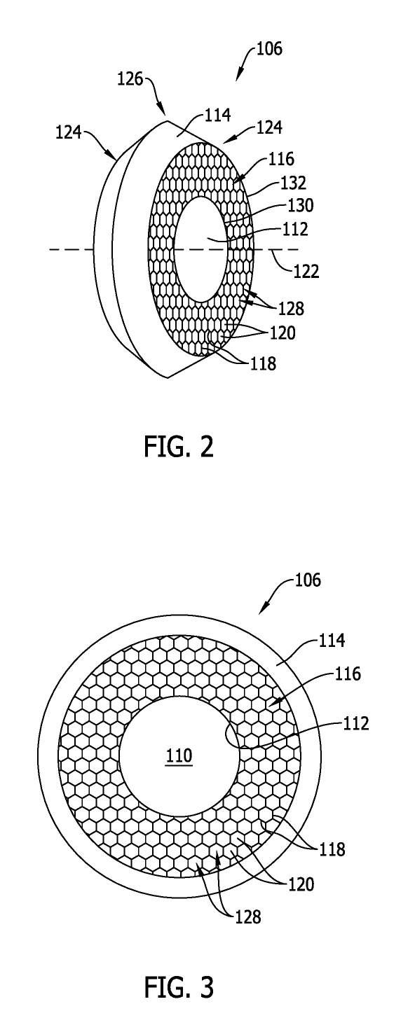

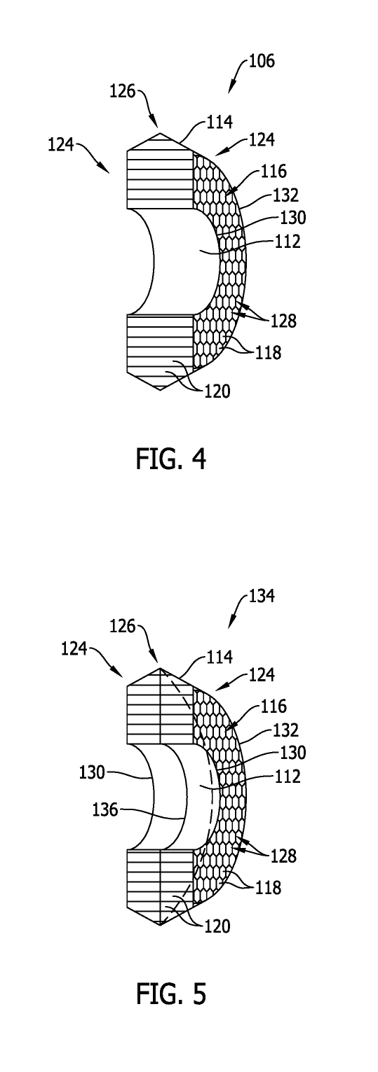

FIG. 2 is a perspective view illustration of grommet 106 that may be used in conduit support assembly 100 (shown in FIG. 1), FIG. 3 is a front view illustration of grommet 106, and FIG. 4 is a perspective cross-sectional view of grommet 106. In the exemplary implementation, grommet 106 includes a radially inner side wall 112, a radially outer side wall 114, and a support structure 116 extending between radially inner side wall 112 and radially outer side wall 114. Support structure 116 includes a plurality of channel walls 118 arranged in a grid-like pattern such that a plurality of hollow passages 120 are defined by the plurality of channel walls 118. As such, the amount of internal space within grommet 106 taken up by the flexible grommet material is reduced, thereby reducing the weight of grommet 106.

The hardness and compressibility of grommet 106 can be selected by modifying at least one parameter of grommet 106. The hardness and compressibility of grommet 106 is selected based at least partially on a desired holding force of grommet 106 to be induced to conduit 108 (shown in FIG. 1). Exemplary parameters of grommet 106 that may be modified include, but are not limited to, a thickness of radially inner side wall 112, a thickness of radially outer side wall 114, a thickness of the plurality of channel walls 118, a cross-sectional shape of the plurality of hollow passages 120 (i.e., the grid-like pattern selected for the plurality of channel walls 118), a side of the plurality of hollow passages 120, or a material used to form grommet 106.

For example, grommet 106 may be fabricated from any material that enables conduit support assembly 100 to function as described herein. Exemplary grommet materials include, but are not limited to rubber materials, silicone materials such as fluorosilicone, thermoplastic materials such as polyvinylene fluoride and polyoxymethylene, RTV, silicone, or a thermoset material. Moreover, the plurality of channel walls 118 can be arranged in any suitable grid-like pattern that enables grommet 106 to function as described herein. As shown, the plurality of channel walls 118 are arranged in a hexagonal-grid pattern, which facilitates increasing the structural rigidity of support structure 116 by providing 360° elastic compressibility about each hexagon.

In the exemplary implementation, radially inner side wall 112 extends circumferentially about a centerline 122 of grommet 106, thereby defining through-hole 110 in grommet 106 sized to receive conduit 108. Radially outer side wall 114 also extends circumferentially about centerline 122 of grommet 106, and includes a pair of end portions 124 and a central portion 126 positioned between the pair of end portions 124. In one implementation, central portion 126 extends a greater radial distance from centerline 122 of grommet 106 than the pair of end portions 124. As such, central portion 126 is sized to mate with a radial indent (not shown) defined within bracket 102 (shown in FIG. 1), thereby restricting lateral movement of grommet 106 relative to bracket 102 along conduit 108.

As described above, the thicknesses of one or both of radially inner side wall 112 and radially outer side wall 114 may be modified to selectively tailor the hardness and compressibility of grommet 106. For example, increasing the thicknesses of one or both of radially inner side wall 112 and radially outer side wall 114 facilitates increasing the hardness of grommet 106. Moreover, the thicknesses of radially inner side wall 112 and radially outer side wall 114 need not be the same. For example, in one implementation, the thickness of radially inner side wall 112 is greater than the thickness of radially outer side wall 114 to increase the durability of radially inner side wall 112 and increase its ability to withstand contact-related wear induced by radial and/or lateral movement of conduit 108 relative to radially inner side wall 112.

Referring to FIGS. 2 and 4, in the exemplary implementation, the plurality of channel walls 118 are oriented such that the plurality of hollow passages 120 extend laterally with centerline 122 of grommet 106. More specifically, support structure 116 is oriented such that each hollow passage 120 of the plurality of hollow passages 120 includes at least one open end 128 exposed at a space defined between a side edge 130 of radially inner side wall 112 and a side edge 132 of radially outer side wall 114. Exposing the at least one open end 128 enables fluid to flow through the plurality of hollow passages 120. For example, when conduit support assembly 100 is positioned within a fluid reservoir (not shown), the fluid contained therein is allowed to flow through the plurality of hollow passages 120. As such, volumetric displacement within the fluid reservoir is reduced when compared to a solid grommet, and support structure 116 remains moist, thereby decreasing the likelihood of premature degradation caused by dehydration of grommet 106.

Moreover, grommet 106 may be formed by any suitable fabrication process such as, but not limited to, an injection molding process, a compression molding process, and a three-dimensional printing process. When formed by an injection molding or compression molding process, side walls 112, 114, and 118 may have any suitable draft angle to facilitate removal of grommet 106 from the molds.

FIG. 5 is a perspective cross-sectional view of a grommet 134 in accordance with a second implementation of the disclosure. In the exemplary implementation, grommet 134 includes an annular stiffening member 136 extending between radially inner side wall 112 and radially outer side wall 114. Annular stiffening member 136 is positioned between opposing side edges 130 of radially inner side wall 112 and opposing side edges 132 of radially outer side wall 114. As such, annular stiffening member 136 facilitates increasing the rigidity of grommet 106. In an alternative implementation, annular stiffening member 136 is positioned at one or both opposing ends of grommet 106, thereby forming a closed seal grommet.

A method supporting conduit 108 within a structure is also described herein. The method includes mounting a first bracket within the structure, and positioning a first grommet within a conduit opening defined in the first bracket. The first grommet includes a radially inner side wall, a radially outer side wall, and a support structure extending between the radially inner side wall and the radially outer side wall. The support structure includes a plurality of channel walls arranged in a grid-like pattern such that a plurality of hollow passages are defined by the plurality of channel walls. The method also includes extending the conduit through a through-hole defined in the first grommet.

In one implementation, the method includes mounting a second bracket within the structure, and selecting a second grommet based on a desired holding force of the conduit within the second bracket. The second grommet is then positioned within a conduit opening defined in the second bracket. The second grommet also includes a radially inner side wall, a radially outer side wall, and a support structure extending between the radially inner side wall and the radially outer side wall, and the support structure includes a plurality of channel walls arranged in a grid-like pattern such that a plurality of hollow passages are defined by the plurality of channel walls. The method also includes extending the conduit through a through-hole defined in the second grommet. As such, the second grommet is selected based on a location of the second bracket within the structure, and the desired holding force for the conduit at the second location.

More specifically, selecting a second grommet comprises selecting the second grommet different from the first grommet in at least one parameter, the at least one parameter including a thickness of the radially inner side wall, a thickness of the radially outer side wall, a thickness of the plurality of channel walls, a cross-sectional shape of the plurality of hollow passages, a size of the plurality of hollow passages, or a material used to form the second grommet.

Further, the method further includes mounting the first bracket within a fluid reservoir, wherein the support structure is oriented such that each hollow passage of the plurality of hollow passages includes at least one open end for receiving fluid contained within the fluid reservoir.

This written description uses examples to disclose various implementations, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A grommet comprising:
a radially inner side wall;
a radially outer side wall; and
a support structure extending between said radially inner side wall and said radially outer side wall, wherein said support structure comprises a plurality of channel walls arranged in a grid-like pattern such that a plurality of hollow passages are defined by said plurality of channel walls.

2. The grommet in accordance with claim 1, wherein said plurality of channel walls are arranged in a hexagonal-grid pattern.

3. The grommet in accordance with claim 1, wherein said radially inner side wall extends about a centerline of the grommet, thereby defining a through-hole in the grommet.

4. The grommet in accordance with claim 3, wherein said radially outer side wall comprises a pair of end portions and a central portion positioned between said pair of end portions, wherein said central portion extends a greater radial distance from the centerline of the grommet than said pair of end portions.

5. The grommet in accordance with claim 3, wherein said plurality of channel walls are oriented such that said plurality of hollow passages extend laterally with the centerline.

6. The grommet in accordance with claim 1, wherein said support structure is oriented such that each hollow passage of said plurality of hollow passages comprises at least one open end exposed at a space defined between a side edge of said radially inner side wall and a side edge of said radially outer side wall.

7. The grommet in accordance with claim 1 further comprising an annular stiffening member extending between said radially inner side wall and said radially outer side wall, said annular stiffening member positioned between opposing side edges of said radially inner side wall and opposing side edges of said radially outer side wall.

8. The grommet in accordance with claim 1, wherein a desirable property of the grommet is selected by varying a thickness of said plurality of channel walls.

9. A conduit support assembly comprising:
a bracket comprising a conduit opening defined therein;
a conduit extending through said conduit opening; and
a grommet positioned between said bracket and said conduit within said conduit opening, said grommet comprising:
a radially inner side wall;
a radially outer side wall; and
a support structure extending between said radially inner side wall and said radially outer side wall, wherein said support structure comprises a plurality of channel walls arranged in a grid-like pattern such that a plurality of hollow passages are defined by said plurality of channel walls.

10. The assembly in accordance with claim 9, wherein said plurality of channel walls are arranged in a hexagonal-grid pattern.

11. The assembly in accordance with claim 9, wherein said radially inner side wall extends about a centerline of said grommet, thereby defining a through-hole in said grommet sized to receive said conduit.

12. The assembly in accordance with claim 11, wherein said radially outer side wall comprises a pair of end portions and a central portion positioned between said pair of end portions, wherein said central portion extends a greater radial distance from the centerline of the grommet than said pair of end portions.

13. The assembly in accordance with claim 11, wherein said plurality of channel walls are oriented such that said plurality of hollow passages extend laterally with the centerline.

14. The assembly in accordance with claim 9, wherein said support structure is oriented such that each hollow passage of said plurality of hollow passages comprises at least one open end exposed at a space defined between a side edge of said radially inner side wall and a side edge of said radially outer side wall.

15. The assembly in accordance with claim 9 further comprising an annular stiffening member extending between said radially inner side wall and said radially outer side wall, said annular stiffening member positioned between opposing side edges of said radially inner side wall and opposing side edges of said radially outer side wall.

16. The assembly in accordance with claim 9, wherein a desirable property of said grommet is selected by varying a thickness of said plurality of channel walls.

17. A method supporting a conduit within a structure, said method comprising:
mounting a first bracket within the structure;
positioning a first grommet within a conduit opening defined in the first bracket, the first grommet including a radially inner side wall, a radially outer side wall, and a support structure extending between the radially inner side wall and the radially outer side wall, wherein the support structure includes a plurality of channel walls arranged in a grid-like pattern such that a plurality of hollow passages are defined by the plurality of channel walls; and
extending the conduit through a through-hole defined in the first grommet.

18. The method in accordance with claim 17 further comprising:
mounting a second bracket within the structure;
selecting a second grommet based on a desired holding force of the conduit within the second bracket;
positioning the second grommet within a conduit opening defined in the second bracket, the second grommet including a radially inner side wall, a radially outer side wall, and a support structure extending between the radially inner side wall and the radially outer side wall, wherein the support structure includes a plurality of channel walls arranged in a grid-like pattern such that a plurality of hollow passages are defined by the plurality of channel walls of the support structure of the second grommet; and
extending the conduit through a through-hole defined in the second grommet.

19. The method in accordance with claim 17, wherein selecting a second grommet comprises selecting the second grommet different from the first grommet in at least one parameter, the at least one parameter including a thickness of the radially inner side wall, a thickness of the radially outer side wall, a thickness of the plurality of channel walls, a cross-sectional shape of the plurality of hollow passages, a size of the plurality of hollow passages, or a material used to form the second grommet.

20. The method in accordance with claim 17 further comprising mounting the first bracket within a fluid reservoir, wherein the support structure is oriented such that each hollow passage of the plurality of hollow passages includes at least one open end for receiving fluid contained within the fluid reservoir.
